(19) United States
(12) Patent Application Publication
(10) Pub. No.: US 2004/0025664 A1
(43) Pub. Date: Feb. 12, 2004

(54) Drummer stick control up-stroke practice method and device

(75) Inventor: Holland Bennett, Syosset, NY (US)

Correspondence Address: HOLLAND BENNETT, 34 MARKET DRIVE, SYOSSET, NY, 11791, US

(73) Assignee: Mr. Holland Whitman Bennett, Syosset, NY (US)

(21) Appl. No.: 10/064,733

(22) Filed: Aug. 12, 2002

(51) Int. Cl. G10D 13/02

(52) U.S. Cl. 84/411 P

(57) ABSTRACT

This invention is to provide a method for improvement of a drummer's stamina, speed, force, control, timing in the delivery of the drum stroke. This is done by providing a practice bar surface located above the drumsticks which the drummer strikes on the up-stroke of the drumstick. The method can be used in conjunction with a standard practice pad to strike on the down-stroke or to provide the upstroke practice bar over open space with no surface to receive the down-stroke.

### BACKGROUND OF INVENTION

Drummers recognize the need for practice devices and methods to allow drummers to develop control, stamina, speed and timing, consistency, force and precision of the drumstick striking the drum surface. Prior devices designed for this purpose are designed to be struck in a down-stroke, in the manner of striking a drum. They provide rebound, audible and sensory feedback to the drummer on the action of the down-stroke of the drum stick.

Most percussion instruments are struck with a downward motion of the drum stick. It is readily understood that control, stamina, speed, timing, consistency, force and precision of the down-stroke is dependent upon the preceding up-stroke which positions the stick to strike and sets the position of the hands and arms, and prepares the muscles to deliver the desired down-stroke. While the sound of the instrument is produced by the down stroke onto the playing surface of the instrument, the quality of the sound is in part determined by the preceding up-stroke or lifting of the drum stick. The control of the down stroke is dependent on the drummers ability to position the stick in space above the drum surface and then move the stick to a precise place on the surface of the instrument. The muscles must be conditioned to develop the stamina to repeatedly perform the drumming action. The speed of successive strokes requires the preceding up-stroke to be performed very rapidly and with an economy of motion. The timing of the stroke depends on the time of completion of the up-stroke, the starting point of the stroke and the speed of the stick. The consistency of the stroke depends on the entire travel path of the stroke starting from the same place at the end of the up-stroke with the same trajectory of motion. The force of the stroke depends on the starting position of the stroke at the end of the up-stroke and the tension and action of the muscles prior to and during the down stroke. Precision of the stroke is the culmination of all of the elements. Accents and ghost notes require that the up-stroke be controlled to be larger or smaller than the other strokes. Generally this requires control of the up-stroke and variations in the up-stroke speed, distance and timing.

This invention is a method of drum training and one embodiment of a device to provide training for the drummer to evaluate and improve the control, stamina, speed, timing, consistency, force and precision of the up-stroke. It provides positive feedback in feel and sound relative to the parameters of the up-stroke.

### SUMMARY OF INVENTION

The invention comprises a method of improving a drummers control, stamina, speed, timing, consistency, force and precision of the up-stroke by providing a striking surface at an adjustable height above a drum practice pad, drum surface or an open space. In use the surface acts as a limit to the upward motion of the drum stick as the drummer performs a plurality of exercises. This limit provides a surface against which the drum stick strikes, offering a target and resistance to allow a drummer to develop an up-stroke with control, stamina, speed, timing, consistency, force and precision. The use of the invention develops the lifting muscles of the arm, wrist and fingers to improve control and stamina. The invention in two modes. It can be used with a drum practice pad or drum to allow the drummer to perform exercises with the sticks striking both the drum or pad surface in the downward direction and the device in the upward direction or it can be suspended over free space, as beyond the edge of a table, to allows the drummer to practice hitting the device in an upward direction only, improving the drummer's control of the stick. The device is designed to accommodate the installation of striking surfaces with different characteristics of rebound and energy absorption. This changes the response of the sticks to striking the surface and forces the drummer to use different levels of muscular effort and control.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

### BRIEF DESCRIPTION OF DRAWINGS

FIG. 1 illustrates the top view of the invention ready to be used with a practice pad positioned on the base plate 1.

FIG. 2 illustrates the front view of the invention as seen from the users position.

FIG. 3 illustrates the side view of the invention

FIG. 4 illustrates horizontal extensions to be installed in the base plate at 9 to allow suspension of the practice surface over an open space.

FIG. 5 illustrates a top view of the invention with the horizontal extensions and practice bar installed.

FIG. 6 illustrates a side view of the invention with the horizontal extensions and practice bar installed.

### DETAILED DESCRIPTION

FIG. 1 illustrates the top view.

Detail 1 is the Base Plate. This supports the vertical elements and allows a standard practice pad to be placed in the traditional position below the up-stroke bar.

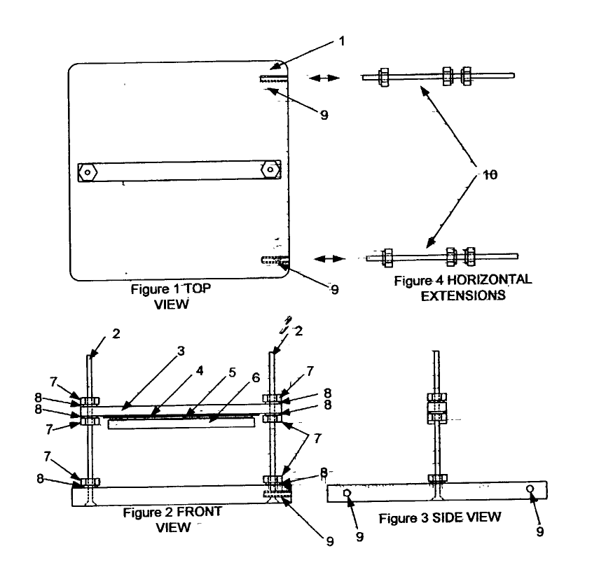

FIG. 2 illustrates the Front view, as seen by the drummer.

Detail 2 is a threaded vertical post mounted securely into the Base Plate (Detail 1). The vertical posts are spaced to fit the corresponding holes in the horizontal bar (Detail 3).

Detail 3 is the horizontal bar which limits the height of the up-stroke. The lower surface of this bar allows the installation of different materials to change the rebound parameters, energy absorption and sound of the stick when it strikes the material. The bar may be adjusted up or down along the vertical members and fixed in place for use.

Detail 4 is a pad of loop and hook fastener material attached to the lower surface of the horizontal bar (Detail 3).

Detail 5 is the matching mate to the material illustrated in Detail 4. This material is attached to each of various striking surfaces and is used to temporarily but firmly attach the striking surface (Detail 6) to be used with the invention.

Detail 6 is one of the various materials to be used as a striking surface for the drummers up-stoke.

Detail 7 is the threaded nut used to secure the horizontal bar (Detail 2) at the selected height. There are 4 such nuts to support the horizontal bar on both sides from both above and below.

Detail 8 is a lock washer to prevent the nuts of Detail 7 from loosening during

FIG. 3 illustrates a side view of the invention.

Detail 9 shows threaded inserts installed in the edge of the base plate (Detail 1) for mounting the horizontal extensions (detail 10)

FIG. 4 illustrates the horizontal extension bars.

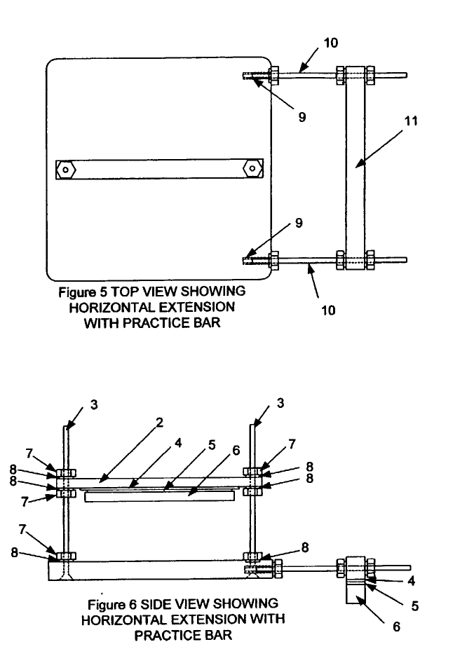

FIG. 5 illustrates a top view showing the horizontal extension bars with the practice bar installed. In this configuration the practice bar is extended horizontally beyond the edge of a table or other surface to permit use of the bar for the up-stroke without a down stroke surface.

Detail 11 is the practice bar for use over an open space. Note that this practice bar is the same as the practice bar shown in details 3, 4, 5 and 6 with the exception that the mounting holes are oriented to mount on the horizontal extensions.

What is claimed is:

1. A method and a device for drummers to develop control, stamina, speed, timing, consistency, force and precision of a drummer's drum stroke. The method consists of providing feedback for the drummer on the control, stamina, speed, timing, consistency, force and precision of the up-stroke of the drum stick. The invention device is a practice bar and mechanism to support the practice bar over the drum sticks to provide a surface to strike during the up-stroke of the drum stick motion. This provides feedback to the drummer regarding the height, speed, timing, muscle control and force of the up-stroke of the drum stick during practice. This also provides a surface to strike at the top of the up-stroke which develops the lifting muscles used by the drummer. While the invention device has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

2. The method and device of claim 1 wherein said device positions a practice bar over a base plate upon which a standard practice pad may be placed.

3. The method and device of claim 1 wherein the system provides a mechanism to vary the height of the practice bar above the surface of the standard practice pad.

4. The method and device of claim 1 wherein there is a method to attach various striking surface materials to the striking surface of the practice bar.

5. The method and device of claim 1 wherein there is a mechanism to suspend the practice bar over an open space to allow the drummer to use the up-stroke against the practice bar without a surface to receive the down-stroke.

6. The method and device of claim 1 wherein the drummers stick control is developed by striking a surface on the up-stroke. Control is especially developed by using the up-stroke surface suspended over an open space with no surface to strike on the down-stroke.

7. The method and device of claim 1 wherein the system will develop the stamina of the drummer. By offering feedback to the drummer on the parameters of the up-stroke the drummer is forced to continue to consistently execute the up-stroke thereby forcing the proper execution of the up-stroke repeatedly and developing stamina and strength in the muscles that control the up-stroke.

8. The method and device of claim 1 wherein the system will develop the drummers speed. By providing audible and sensory feedback at the moment the stick strikes the practice bar on the up-stroke the drummer can develop the ability to perform the up-stroke at the highest speed.

9. The method and device of claim 1 wherein the system will develop the drummers timing. As the stick strikes the practice bar on the up-stroke a sound is emitted that allows the drummer to determine the timing of the up-stroke with respect to the rhythm and the timing of the other up and down strokes.

10. The method and device of claim 1 wherein the system will develop the consistency of the up-stroke and the following down-stroke. By providing a surface and positive feedback to the drummer regarding the up-stroke the drummer develops a consistent and repeatable down-stroke.

11. The method and device of claim 1 wherein the system will develop control of the force of the down stroke by getting feedback as to the force of the up-stroke. This feedback is provided by the amplitude of the sound of the stick striking the practice bar.

12. The method and device of claim 1 wherein the system develops the precision of the drum stroke by providing feedback to the drummer on all parameters of the up-stroke.
